(19) United States
(12) Patent Application Publication
(10) Pub. No.: US 2024/0083128 A1
(43) Pub. Date: Mar. 14, 2024

(54) DEVICE FOR THE POST-TREATMENT OF VULCANIZED TIRES

(71) Applicant: HARBURG-FREUDENBERGER MASCHINENBAU GMBH, Hamburg (DE)

(72) Inventors: Fokko ERDMANN, Adendorf (DE); Stefan BAHLKE, Lüneburg (DE)

(21) Appl. No.: 18/275,077

(22) PCT Filed: Jan. 13, 2022
(86) PCT No.: PCT/DE2022/100028

§ 371 Date: Jul. 31, 2023

(30) Foreign Application Priority Data
Feb. 1, 2021 (DE) 10 2021 102 256.8

(51) Int. Cl. B29D 30/06

(52) U.S. Cl. CPC B29D 30/0643; B29D 2030/0639

(57) ABSTRACT

A device for the post-treatment of vulcanized tires having an improved frame construction, which is made possible in particular by the use of pneumatic drives and a mechanical interlock of the stations. The post-treatment device has at least one station for post-treatment of a tire and at least one support gas supply device that subjects the tire in the station to a pressure from the inside, the device having exactly one support column.

The invention relates to a device for the post-treatment of vulcanized tires.

The invention relates additionally to a tire heating press having at least one device for the post-treatment of vulcanized tires.

Devices for the post-treatment of vulcanized tires, also called post cure inflators (PCI), are already known, which devices apply a pressure to the tires, which have been at least partially vulcanized by means of tire heating presses, from the inside and thermally treat them in a more or less controlled manner, wherein the tires can be fully vulcanized by the supply of heat or can be cooled by the extraction of heat.

By means of such post-treatment devices, which are available both as stand-alone machines and in the form of a unit with a tire heating press, it is possible in particular to cool a vulcanized tire, which is still hot and, owing to its temperature, is still readily plastically deformable by applied external forces, in such a way that very high accuracies can be achieved in respect of the dimensions of the tire and the concentricity of the tire.

Post-treatment devices having a plurality of stations are advantageous in particular, so that a plurality of tires can be post-treated at the same time. For example, it is known to arrange two stations one above the other in a module. Post-treatment devices having four stations in combination with double tire heating presses have been found to be particularly advantageous, wherein in each case two stations are arranged one above the other in a module. Such a post-treatment device is disclosed in DE 10 2015 016 882 A1, for example.

Such post-treatment devices frequently have a high degree of automation, wherein all the stations of the post-treatment device can be controlled independently.

For the post-treatment of the at least partially vulcanized tires, a post-treatment device according to the prior art has two rim plates at each station. The tire can be clamped between these rim plates in the region of the cores in such a way that the interior of the tire is sealed. After sealing, a pressure can be applied to the interior of the tire by the introduction of a support gas, wherein the fixing of the tire at the desired size in relation to the width of the tire (approximately the distance from core to core) takes place by means of a closing force which can be transmitted to at least one rim plate by means of at least one hydraulic cylinder (interlock).

The pressure that can be generated in the interior of one or more tires by means of such a post-treatment device is in a range of up to approximately 4 bar for applications in the production of car tires; for thick-walled bias tires (e.g. motor scooters, agricultural machines, construction machines, etc.), approximately from 6 bar to 7 bar are conventional.

The maximum closing force of such a post-treatment device is approximately 170 kN.

The individual stations each have a surrounding frame which, in particular owing to the hydraulic interlock and the high pressures during the post-treatment, must have a stable and thus material- and cost-intensive design. The sub-frame arranged beneath the stations, by which the forces that occur can be dissipated into the floor, is also necessary and complex.

In order to ensure the necessary stability, the frame of the post-treatment device has at least two supporting columns for each module (a module having at least one station, optionally a plurality of stations arranged one above the other per module), which in the case of two supporting columns are arranged on opposite sides of the module. The supporting columns are connected together above and below each station by means of a cross-member.

The frame so formed is very stable and solid but has a high weight and a great height.

The weight of known post-treatment devices having four stations in two modules is approximately 3500 kg, and the height of the post-treatment device with a sub-frame is of the order of magnitude of approximately 4.6 m.

An object of the invention is to provide a post-treatment device for at least partially vulcanized tires which has an improved construction compared to the prior art with regard to the frame.

This object is achieved by a post-treatment device for at least partially vulcanized tires as claimed in patent claim 1.

A further object of the invention is to provide a post-treatment device for at least partially vulcanized tires which has a reduced size.

This object is achieved according to the invention by a post-treatment device for at least partially vulcanized tires as claimed in patent claim 4.

A further object of the invention is to create a tire heating press which solves the problems mentioned above.

This object is achieved by a tire heating press as claimed in patent claim 11.

The features of a post-treatment device that are disclosed hereinbelow are part of the invention both individually and in all executable combinations.

A post-treatment device according to the invention has at least one station for the post-treatment of an at least partially vulcanized tire.

A post-treatment device according to the invention further has a pneumatic supply means for introducing and for releasing support gas into or from a tire to be treated, so that a pressure can be applied from the inside to a tire to be treated.

The frame of a post-treatment device according to the invention has exactly one vertically oriented supporting column, to which the upper and lower cross-members of each station are fastened.

In a preferred embodiment of the invention, the post-treatment device has two stations for the post-treatment of an at least partially vulcanized tire.

In a particularly preferred embodiment of the invention, the post-treatment device has four stations for the post-treatment of an at least partially vulcanized tire, wherein in each case two stations are arranged one above the other.

In one embodiment of the invention, the device has at least two stations, wherein at least two of the stations of the post-treatment device, when seen in a plan view, are arranged on opposite sides of the supporting column.

In another embodiment of the invention, at least two of the stations, when seen in a plan view, are arranged at an angle of less than 180° relative to one another, so that the width of the post-treatment device is reduced compared to stations arranged opposite.

In one embodiment of the invention, at least two of the stations, when seen in a plan view, are arranged approximately at a right angle (90°) relative to one another.

According to the invention, the reduction in the width of the post-treatment device can also be achieved by arranging the stations in an angle range relative to one another of from slightly less than 90° to slightly less than 180°, when seen in a plan view, wherein the minimum angle is dependent on the diameter of the individual stations and on the loading and unloading device that is used.

In one embodiment of the invention, each station of the post-treatment device has two rim plates between which a tire for post-treatment can be fixed. For fixing the tire, at least one of the rim plates is displaceable, so that the distance from the respective other rim plate can be changed.

In a preferred embodiment of the invention, exactly one rim plate per station is displaceable and the respective other rim plate is arranged fixedly and immovably on the associated cross-member.

In a preferred embodiment of the invention, the device has, per station, at least one pneumatic drive with which the displaceable rim plates of the post-treatment device are pneumatically drivable. For the interlock of the individual treatment stations, the post-treatment device according to the invention has in each case an associated mechanical interlock means.

By combining a pneumatic drive for the rim plates with a mechanical interlock means, it is possible according to the invention to dispense with the use of hydraulic cylinders. A power flow through a frame surrounding each station externally is thus no longer necessary.

In one embodiment of the invention, the mechanical interlock means is in the form of a hammer-head locking system or in the form of a mushroom-head locking system.

In one embodiment of the invention, the post-treatment device has, per station, a push-off device with which the tire of the station in question can be pushed off the rim plate in question after the post-treatment of the tire. Adhesion of the tires to the rim plates is thus reduced, and removal of the tires from the post-treatment device is assisted.

In one embodiment of the invention, the device has at least two stations, wherein the stations, at least in pairs, achieve a consistently joint mode of operation.

A paired association of the stations for the purpose of a consistently joint mode of operation allows the post-treatment device to be optimally adapted to use with a double tire heating press, so that the tires removed from the vulcanization chambers of the heating press in one production cycle can simultaneously be post-treated.

The implementation of the consistently joint mode of operation is effected by the joint use of the control means of the pneumatic system by the respective associated stations, so that all the associated stations are activated identically.

In particular, in one embodiment of the invention, the pneumatic lines for the introduction of support gas into the tires in the respective stations and for removing air from the tires in the respective stations are connected together, so that the admission of the support gas to all the associated stations takes place simultaneously by way of a centrally controlled valve.

In one embodiment of the invention, the pneumatic drives of the displaceable rim plates of the associated stations are connected together, so that an approximately synchronous displacement of the rim plates of the associated stations takes place.

In one embodiment of the invention, the pneumatic lines of the push-off devices of the associated stations are connected together, so that they can be actuated simultaneously by way of a centrally controlled valve.

In one embodiment of the invention having four stations, the stations are associated with one another in pairs for the purpose of the consistently joint mode of operation, wherein in each case the two upper stations and the two lower stations are associated with one another.

In one embodiment of the invention, the pneumatic means of all the stations of the post-treatment device are configured such that they are actuated in the same way for all the stations.

In a preferred embodiment of the invention, the post-treatment device has a width-adjusting means for each post-treatment station, with which the distance of the rim plates in the closed state of the post-treatment station is adjustable. Tires of different widths can thus be treated using one post-treatment device.

Particularly preferably, the width-adjusting means has fixed mechanically adjustable stops, so that the respective displaceable rim plate can be displaced to a first mechanical stop for the open state of the post-treatment station and to a second mechanical stop for the closed state of the post-treatment station.

Advantageously, initiators or switches are installed in the region of the mechanical stops for monitoring the end positions, so that the drive of the displaceable rim plate is correspondingly activatable.

The use of fixed mechanically adjustable stops for the width-adjusting means makes it possible to dispense with a displacement-measuring system which requires expensive measurement technology.

In an advantageous embodiment of the invention, the device has a push-off means for each post-treatment station, with which a post-treated tire can be pushed off the upper (displaceable) rim plate. Otherwise, a post-treated tire, if it adheres to the displaceable rim plate, could be moved upward with the rim plate and be damaged thereby or by falling down.

A post-treatment device for at least partially vulcanized tires according to the invention further has the following advantages:
A stationary installation of the components is possible
The post-treatment device can be loaded and emptied directly by the unloader of an associated heating press
Alternatively, however, this can also be carried out by a separate loading and unloading device associated with the post-treatment device
The construction is space-saving at the installation site
The structure of small modular and easily manageable units permits manufacture in small and simple machines

A tire heating press according to the invention has at least one post-treatment device according to the invention.

Preferably, the post-treatment device is arranged such that the unloader of the tire heating press can be used as the loader and unloader of the post-treatment device.

In the figures described hereinbelow, details of exemplary embodiments of the invention are shown schematically, wherein:

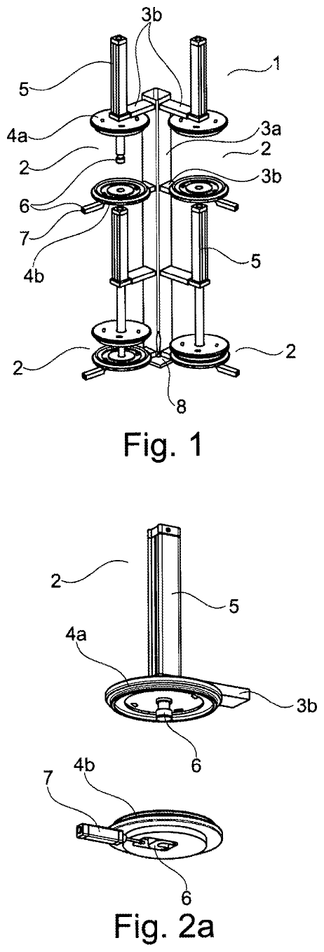

FIG. 1: is a perspective view of a post-treatment device according to the invention having four stations,

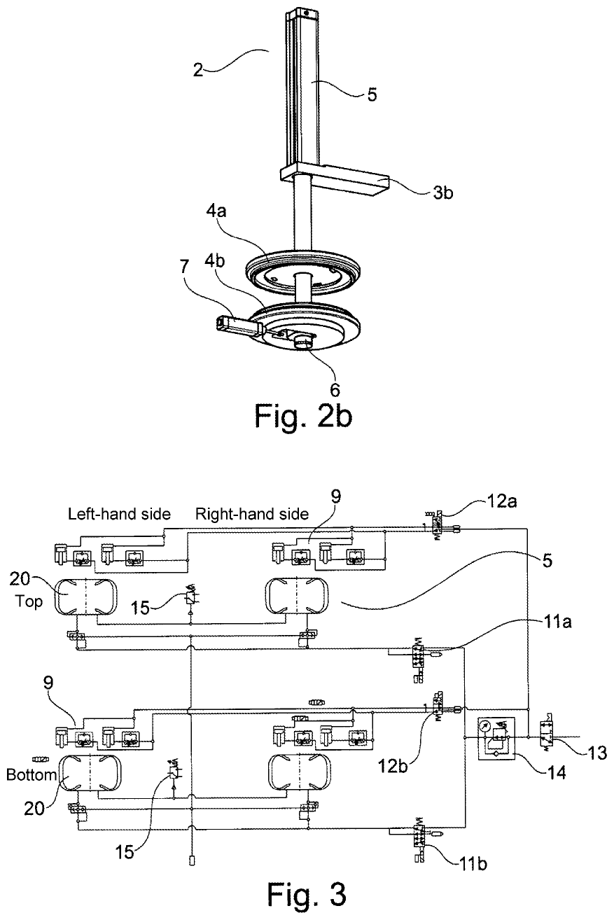

FIG. 2a: shows a station of a post-treatment device according to the invention in an open state,

FIG. 2b: shows a station of a post-treatment device according to the invention in a closed state, and

FIG. 3: is a schematic representation of the pneumatic system of an embodiment of a post-treatment device according to the invention.

FIG. 1 is a perspective view of a post-treatment device (1) according to the invention having four stations (2). The post-treatment device (1) has a frame, which consists of a single central supporting column (3a) and cross-members (3b) attached to the supporting column (3a) in the region of the stations (2). Each station (2) is arranged in the region of two cross-members (3b), which are each connected at a distance above one another to the supporting column (3a). The stations (2) arranged one above the other in each case share a cross-member (3b), so that the post-treatment device (1) has a total of six cross-members (3b).

Each station (2) has a displaceable rim plate (4a) and a stationary rim plate (4b), wherein the displaceable rim plate (4a) is movable by means of a pneumatic drive (5) in the direction toward the stationary rim plate (4b) or away from the stationary rim plate. The displaceable rim plate (4a) is always the upper rim plate (4a), since a post-treated tire can thus remain on the lower rim plate (4b) when the post-treatment station (2) is opened. In the embodiment shown, the movement axis is oriented vertically and approximately parallel to the supporting column (3a).

The stations (2) are each equipped with a mechanical interlock (6), which are in the form of hammer-head locking systems. To that end, the displaceable rim plate (4a) has a pin projecting centrally therefrom in the direction toward the stationary rim plate (4b) of the station (2), the head region of which pin is in the form of a hammer head. The stationary rim plate (4b) has in its center a through-opening, through which the pin of the displaceable rim plate (4a) passes when the displaceable rim plate is displaced by means of the pneumatic drive (5) in the direction toward the stationary rim plate (4b). Beneath the stationary rim plate (4b) of the station (2) there is arranged a latch element, which encloses the hammer head of the pin in a locked state of the station (2) to form a positive connection. To that end, the latch element is movable by means of a locking drive (7).

On its underside, the supporting column (3a) has a mounting plate (8), with which the post-treatment device (1) can be fastened directly to the floor of the production site.

FIGS. 2a and 2b show a station (2) of an embodiment according to the invention of a post-treatment device (1) in an open state (FIG. 2a) and in a closed state (FIG. 2b). There can be seen in particular the latch element, arranged on the underside of the stationary rim plate (4b), of the mechanical interlock (6), which latch element is movable forward and backward along an axis by means of the locking drive (7).

FIG. 3 shows a schematic representation of at least part of the pneumatic system of an embodiment of a post-treatment device (1) according to the invention, wherein the post-treatment device (1) has four stations (2), in each of which there is arranged a tire (20) to be post-treated.

The post-treatment device (1) has for each station (2) a feed means for a support gas, with which a pressure can be applied from the inside to the tire (2) located in the respective station (2). The feed means of the stations are pneumatically connected together such that the two upper stations (2) can be supplied with support gas by way of a common upper feed valve (11a) and the two lower stations (2) can be supplied with support gas by way of a common lower feed valve (11b).

The post-treatment device (1) further has for each station (2) a push-off means (9) with which a post-treated tire (20) can be pushed off the displaceable rim plate (4a). The push-off means (9) are pneumatically connected together such that the push-off means (9) of the upper stations (2) are controllable by way of a common upper push-off valve (12a) and the push-off means (9) of the lower stations are controllable by way of a common lower push-off valve (12b).

A consistently joint mode of operation of the upper and lower stations (2) of the post-treatment device (1) is thus achieved.

The post-treatment device (1) further has a main valve (13) for the pneumatic system, consisting at least of the supply to the push-off means (9) and the feed means for support gas, with which the pneumatic supply can be controlled or switched centrally.

In the region of the feed means, the post-treatment device (1) has a pressure control valve (14) with which the pressure of the support gas fed to the stations (2) can be controlled. The upper and lower stations (2) each have a common pressure-measuring means (15), so that the pressure which can be introduced into the tires (20) can be controlled by means of the post-treatment device (1).

1-11. (canceled)

12. A post-treatment device for at least partially vulcanized tires, comprising: at least one station for post-treatment of a tire; at least one support gas feed arranged in the at least one station to apply a pressure from inside to a tire; and exactly one supporting column.

13. The post-treatment device according claim 12, wherein the at least one station includes at least two stations for the post-treatment of tires.

14. The post-treatment device according claim 13, wherein each of the stations has a pneumatic drive for driving at least one displaceable rim plate, further comprising a mechanical locking system that interlocks the stations.

15. The post-treatment device according claim 14, wherein the mechanical locking system is a hammer-head locking system.

16. The post-treatment device according claim 12, wherein the supporting column is configured to be mountable directly on a floor of a production site without a sub-frame.

17. The post-treatment device according claim 13, wherein the stations connected to the supporting column at substantially an equal height and are arranged at an angle of less than 180° relative to one another at the supporting column.

18. The post-treatment device according claim 13, wherein the at least two stations are pneumatically connected so as to provide a consistent joint mode of operation of the at least two stations.

19. The post-treatment device according claim 13, wherein the at least two stations are arranged above one another on the supporting column.

20. The post-treatment device according claim 13, wherein the at least two stations include four stations, wherein, in each case, two of the stations are arranged above one another.

21. The post-treatment device according claim 20, wherein the stations are associated in pairs for, in each case, a consistently joint mode of operation.

22. A tire heating press, comprising at least one post-treatment device according claim 12.
